(19) United States
(12) Patent Application Publication
(10) Pub. No.: US 2025/0379440 A1
(43) Pub. Date: Dec. 11, 2025

(54) CHARGER

(71) Applicant: LG ELECTRONICS INC., Seoul (KR)

(72) Inventors: Junyeop JEONG, Seoul (KR); Sunghwan OH, Seoul (KR); Myoungku LEE, Seoul (KR); Jiho LEE, Seoul (KR); Sunghoon KANG, Seoul (KR)

(73) Assignee: LG ELECTRONICS INC., Seoul (KR)

(21) Appl. No.: 18/819,782

(22) Filed: Aug. 29, 2024

(30) Foreign Application Priority Data
Jun. 5, 2024 (WO) PCT/KR2024/007745

(51) Int. Cl. H02G 11/02; B60L 53/18; B60L 53/31; H02J 7/00

(52) U.S. Cl. CPC H02G 11/02; B60L 53/18; B60L 53/31; H02J 7/0042

(57) ABSTRACT

A charger comprises a body installed on a frame of a charger body and having a space therein; a weight assembly accommodated in the space to be capable of being raised and lowered; and a wire connected to the charging cable and raising the weight assembly; in which the weight assembly may comprise a tray with an inner space formed; and at least one weight accommodated in the inner space, and the weight of the weight assembly may vary according to the number of weights accommodated in the inner space.

### CROSS-REFERENCE TO RELATED APPLICATION

Pursuant to 35 U.S.C. § 119, this application claims the benefit of an earlier filing date and right of priority to International Application No. PCT/KR2024/007745, filed on Jul. 5, 2024, the contents of which are hereby incorporated by reference herein in its entirety.

### BACKGROUND

The present disclosure relates to a charger.

A charger is a device used to charge storage batteries.

An example of a charger may be an electric vehicle charger that charges vehicles such as electric vehicles, and electrical energy is supplied to the battery of the electric vehicle by connecting the charging connector provided at the end portion of the charging cable to the connection inlet installed in the electric vehicle.

The charger comprises a power module to which a charging cable is connected, and a charger body that forms a space in which the power module is accommodated.

The user may connect to the vehicle after taking out the connector (charging gun or plug) provided on the charging cable from the charger body.

In U.S. Pat. No. 11,260,767 B2 (patent dated May 1, 2022), a cable recovery system including a wire connected to a charging cable is disclosed, the cable recovery system comprises an enclosure having an opening, a movable pulley movably accommodated in the enclosure. a movable counterweight fastened to a movable pulley, a ring fixed to the inside of the enclosure, a pulley disposed around the opening of the enclosure, and wire having one end fastened to the ring and the other end fastened to a cable, and lifting and lowering the movable pulley.

### SUMMARY

An object of this embodiment is to provide a charger in which the total weight of the weight may be easily varied according to the weight of the charging cable.

A charger according to the present embodiment comprises a body installed on a frame of a charger body and having a space therein; a weight assembly accommodated in the space to be capable of being raised and lowered; and a wire connected to the charging cable and raising the weight assembly; in which the weight assembly may comprise a tray with an inner space formed; and at least one weight accommodated in the inner space.

The charger may further comprise first and second fixing pulleys installed on the body.

The weight assembly may further comprise a lifting and lowering pulley disposed on the tray; and a wire connector disposed on the tray and connected to the wire.

The wire may be sequentially wound around the first fixing pulley, the lifting and lowering pulley, and the second fixing pulley.

The weight assembly may further comprise a roller for movement control disposed on the tray and in contact with an inner surface of the tray.

The roller for movement control may further comprise a first roller configured to rotate around a central axis in a front and rear direction; and a second roller configured to rotate around a central axis in a left and right direction.

The roller for movement control may comprise an upper roller rotatably disposed on an upper surface of the tray; and a lower roller rotatably disposed on a lower surface of the tray.

The weight assembly may further comprise a front cover coupled to the tray to prevent the weight from leaving.

The charger may further comprise a left cover coupled to a front surface of the body; and a right cover coupled to the front surface of the body and spaced apart from the left cover in the left and right direction.

A wire through-hole through which the wire passes may be formed in the body, and the wire extends outside the body and may be connected to the charging cable.

The charging cable may comprise a cable body extending outside of the charger body.

One end of the wire may be connected to the weight assembly, and the other end of the wire may be connected to the cable body.

The charger may further comprise a stopper disposed on an upper surface of a lower plate part of the body.

The weight assembly may further comprise a weight balancer disposed on a lower surface of the tray.

A protrusion may protrude from the stopper, and a groove into which the protrusion is inserted may be formed on a lower surface of the weight balancer.

The charger may further comprise a top stopper disposed on the tray to protrude toward the inner space.

### BRIEF DESCRIPTION OF THE DRAWINGS

FIG. 1 is a front view illustrating a charger according to this embodiment,

FIG. 2 is a front view illustrating a state where the wire device according to this embodiment is installed on the frame,

FIG. 3 is an exploded perspective view illustrating the wire device according to this embodiment,

FIG. 4 is a front view illustrating the weight assembly according to this embodiment,

FIG. 5 is a front view illustrating the inside of the wire device according to this embodiment,

FIG. 6 is an enlarged perspective view illustrating the upper surface of the weight assembly according to this embodiment,

FIG. 7 is an enlarged perspective view illustrating the lower surface of the weight assembly according to the present embodiment, and

FIG. 8 is a perspective view illustrating the lower plate of the body when the weight assembly according to this embodiment is lifted.

### DETAILED DESCRIPTION OF THE EMBODIMENTS

Hereinafter, specific embodiments of the present disclosure will be described in detail along with the drawings.

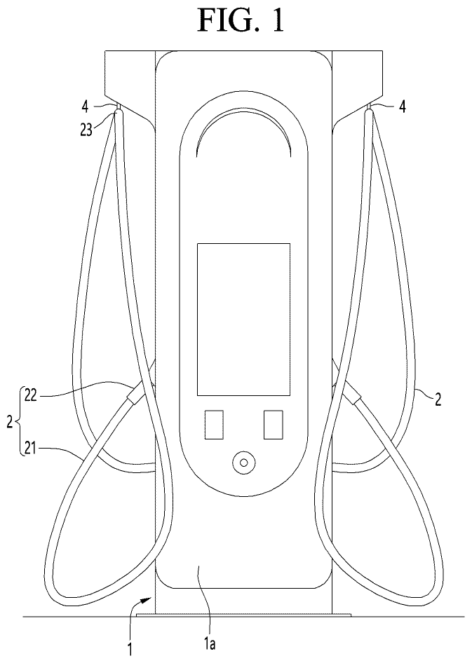

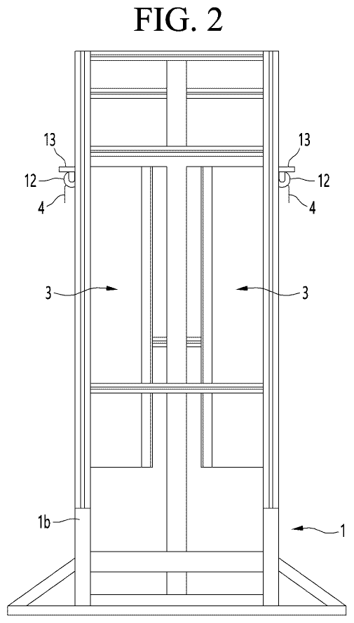

FIG. 1 is a front view illustrating a charger according to this embodiment, and FIG. 2 is a front view illustrating a state where the wire device according to this embodiment is installed on the frame.

The charger may comprise a charger body 1 and a charging cable 2.

The charger body 1 may comprise a case 1a that forms the outer appearance of the charger, and a frame 1b that supports the case 1a.

The frame 1b may be positioned inside case 1a and may be protected by case 1a. The frame 1b may comprise an aluminum frame made of aluminum material. A power supply unit to which one end of the charging cable 2 is connected may be accommodated inside the charger body 1. The power supply unit may comprise a power module, a power supply, or the like.

The charging cable 2 may penetrate the charger body 1, particularly the case 1a.

The charging cable 2 may comprise a connection body located inside the charger body 1, a cable body 21 extending to the outside of the charger body 1, and a connector 22 installed on the cable body 21.

The connection body may be connected to a power supply accommodated inside the charger body 1.

The cable body 21 may comprise a charging line and a shell surrounding the outer circumference of the charging line.

The cable body 21 may pass through a through-hole formed in the charger body 1.

The connector 22 may be connected to or separated from the inlet of a vehicle, such as an electric vehicle and may charge a vehicle, such as an electric vehicle.

A connector holder on which the connector 22 is mounted may be formed on the charger body 1.

After the connector 22 of the charging cable 2 is separated from the connector holder, the cable body 21 may be extended close to the vehicle, and the connector 22 may be connected to the inlet of the vehicle.

The charger may comprise a wire device 3 that may pull the charging cable 2, in particular one side of the cable body 21, into the charger body 1.

One side 23 of the cable body 21 may be defined as a portion of the cable body 21 to which the wire 4 is connected. One side 23 of the cable body 21 may be closer to the connector 22 among the connection body and connector 22 of the charging cable 2.

The wire device 3 may comprise a wire 4 connected to one side 23 of the cable body 21.

An example of the wire 4 is connected to a cable cover (not illustrated) provided on one side 23 of the cable body 21, so that one side 23 of the charging body 21 may be pulled to the charger body 1.

Another example of the wire 4 comprises a loop connected to one side 23 of the cable body 21, so that one side 23 of the cable body may be pulled to the charger body 1.

The wire device 3 may comprise a retractor, spring balancer, or weight that may pull the wire 4 inside the charger body 1.

If the wire device 3 comprises a retractor or spring balancer, the load may gradually increase as the movable length of the wire 4 increases, and if the wire device 3 comprises a weight, even if the movable length of the wire 4 increases, the load may be constant.

Here, the movable length of the wire 4 may be defined as the length of the wire 4 extending outside of the charger body 1, and the load may be the force pulling the wire 4 to the outside of the charger body 1.

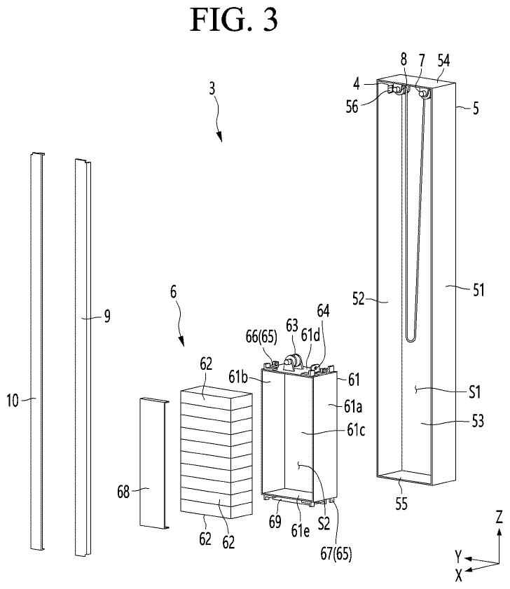

The wire device 3 preferably comprises a weight 62 (see FIGS. 3 to 5) so that the user may pull the connector 22 with a constant force (load), and hereinafter is described as comprising a weight 62.

The wire device 3 may correspond 1:1 to the charging cable 2. When a plurality of charging cables 2 are provided in the charger, a plurality of wire devices 3 may be provided inside the cable body 1.

When the charger comprises a left charging cable and a right charging cable, the wire device may comprise a left wire device and a right wire device. The left wire device and the right wire device may be disposed spaced apart from each other or may be disposed in contact with each other.

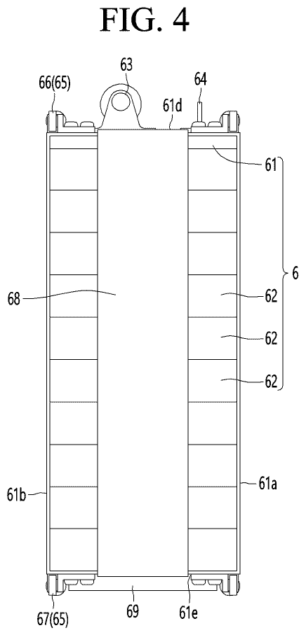

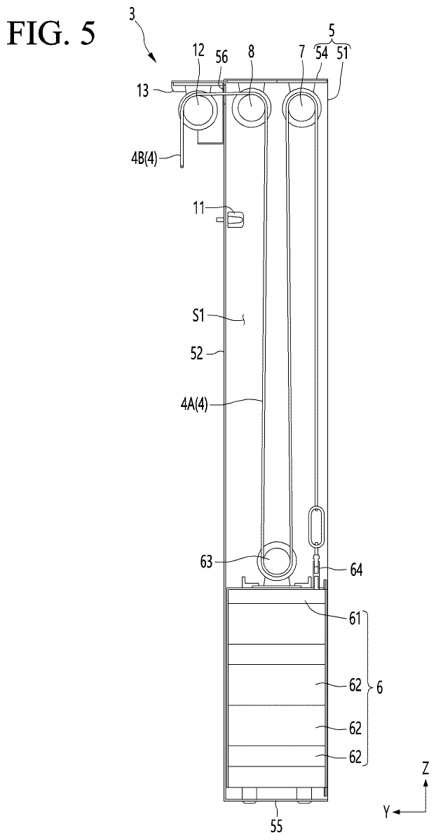

FIG. 3 is an exploded perspective view illustrating the wire device according to this embodiment, FIG. 4 is a front view illustrating the weight assembly according to this embodiment, and FIG. 5 is a front view illustrating the inside of the wire device according to this embodiment.

The wire device 3 comprises a body 5 installed on the frame 1b and having a space S1 therein; and a weight assembly 6 that is accommodated in the space S1 so as to be capable of being lifted and lowered.

The wire 4 may be connected to the charging cable 2 and the weight assembly 6, respectively.

One end of the wire 4 may be connected to the weight assembly 6, and a loop or the like connected to the charging cable 2 may be disposed on the other end of the wire 4.

The other end of the wire 4 may be connected to the cable body 21 of the charging cable 2.

The wire 4 may extend outside of the body 5.

The wire 4 may comprise an inner wire 4A accommodated in space S1 with the weight assembly 6, and an outer wire 4B extending from the inner wire 4A and located outside the body 5.

The wire 4 may be pulled out of the charger body 1 when one side 23 of the charging cable 2 moves away from the charger body 1, and at this time, the weight assembly 6 may be lifted.

The wire 4 may be pulled by the weight assembly 6, inserted into the interior of the charger body (1), and pull one side 23 of the charging cable 2 into close contact with the charger body 1.

The body 5 may form the outer appearance of the wire device 3 and protect the weight assembly 6.

The body 5 may have a box shape with an open front.

As illustrated in FIG. 3, the body 5 may comprise a left plate 51, a right plate 52, a rear plate 53, an upper plate 54, and a lower plate 55.

The body 5 may be disposed long in the vertical direction (Z) on the frame 1b.

The body 5 may be fastened to the frame 1b using fastening members such as brackets and screws.

A wire through-hole 56 through which the wire 4 passes may be formed in the body 5. The wire through-hole 56 may be formed in at least one of the left plate 51 and the right plate 52 of the body 5.

The body 5 may guide the lifting and lowering of the weight assembly 6. The inner surface of the body 5 may be a guide surface that guides the lifting and lowering of the weight assembly 6.

The wire device 3 may comprise first and second fixing pulleys 7 and 8 installed on the body 5.

The first and second fixing pulleys 7 and 8 guide the wire 4 and may guide the movement of the wire 4 while the height is maintained constant.

The wire 4 may slide along the first and second fixing pulleys 7 and 8.

The first and second fixing pulleys 7 and 8 may be disposed to be accommodated in the space S1.

The first and second fixing pulleys 7 and 8 may be disposed on the upper plate 54. The first and second fixing pulleys 7 and 8 may be disposed to be spaced apart from each other in the horizontal direction on the upper plate 54.

The first and second fixing pulleys 7 and 8 may be disposed on the lower surface of the upper plate 54 to be spaced apart from each other in the left and right direction Y.

Each of the first and second fixing pulleys 7 and 8 may comprise a bracket fastened to the upper plate 54 with a fastening member such as a screw, and a roller rotatably disposed on the bracket. The roller may be rotatably connected to the bracket about a horizontal axis.

The weight assembly 6 may comprise a tray 61 having an inner space S2 formed thereon; and at least one weight 62 accommodated in the inner space S2.

The tray 61 may have a box shape with an open front.

As illustrated in FIG. 3, the tray 61 may comprise a left plate 61a, a right plate 61b, a rear plate 61c, an upper plate 61d, and a lower plate 61e, and the left plate 61a, the right plate 61b, the rear plate 61c, the upper plate 61d, and the lower plate 61e may form the inner space S2.

The size of the tray 61 may be smaller than the size of the body 5. The size of the tray 61 may be larger than the weight 62.

The tray 61 may be accommodated in the body 5 to be lifted and lowered in the vertical direction Z.

The weight assembly 6 may further comprise a lifting and lowering pulley 63 disposed on the tray 61; and a wire connector 64 to which the wire 4 is connected.

The lifting and lowering pulley 63 may be disposed on the upper side of the upper plate 61d of the tray 61.

The lifting and lowering pulley 63 may comprise a lifting and lowering bracket fastened to the upper surface of the upper plate 61d of the tray 61 with a fastening member such as a screw, and a lifting and lowering roller rotatably disposed on the lifting and lowering bracket. The lifting and lowering roller may be rotatably connected to the lifting and lowering bracket about a horizontal axis. The lifting and lowering pulley 63 may comprise an inner pulley disposed inside the body 5.

The wire connector 64 may be spaced apart from the lifting and lowering pulley 63 in the horizontal direction.

The wire connector 64 may be fastened to the upper surface of the upper plate 61d of the tray 61 using a fastening member such as a screw.

An example of the wire connector 64 may comprise a bracket fastened with a screw or the like to the upper surface of the upper plate 61d of the tray 61 and to which one end of the wire 4 is connected.

Another example of the wire connector 64 may comprise a turnbuckle fastened with screws or the like to the upper surface of the upper plate 61d of the tray 61, an eyebolt coupled to the turnbuckle, and a loop to which one end of the wire is connected.

Of course, the type of wire connector 64 is not limited as long as the wire connector may firmly connect the wire 4 to the tray 61.

The wire 4 may be sequentially wound around the first fixing pulley 7, the lifting and lowering pulley 63, and the second fixing pulley 8.

When the wire device 3 comprises all of a wire connector 64, a first fixing pulley 7, a lifting and lowering pulley 63, and a second fixing pulley 8, the inner wire 4A may comprise a first inner wire portion located between the wire connector 64 and the first fixing pulley 7, a second inner wire portion located between the first fixing pulley 7 and the lifting and lowering pulley 63, and a third inner wire portion located between the lifting and lowering pulley 63 and the second fixing pulley 8.

The inner wire 4A may extend in a substantially zigzag shape in the space S1.

If the wire device 3 comprises only the wire connector 64 and the first fixing pulley 7, without the lifting and lowering pulley 63 and the second fixing pulley 8, in the inside of the body 5, the second inner wire portion and the third inner wire portion may not be extended, and only the first inner wire portion may be extended.

On the other hand, when the wire device 3 comprises all of a wire connector 64, a first fixing pulley 8, a lifting and lowering pulley 63, and a second fixing pulley 8, in the inside of the body 5, the first inner wire portion, the second inner wire portion, and the third inner wire portion may all be extended, and the wire device 3 may accommodate more wire portion inside the body 5 by the sum of the length of the second inner wire portion and the length of the third inner wire portion, and the wire device 3 may secure a sufficiently long the movable length extending to the outside of the charger body 1.

The weights 62 may be disposed singly or in plural numbers in the inner space S2 of the tray 61.

The weight assembly 6 may have a variable number of weights 62. Two or more weights 62 may be stacked, and as the number of weights 62 accommodated in the inner space S2 increases, the weight of the tray assembly 6 may increase.

For example, the tray 61 may be 3 kg, the weight 62 may be 3 kg, up to 9 weights 62 may be stacked in the inner space S2 of the tray 61, and the total weight of the weight assembly 6 may be 30 kg.

The number of weights 62 may be determined according to the weight of the charging cable 2 to which the wire 4 is connected.

The weight of the charging cable 2 may be different according to the power capacity or heating method (air-cooled or water-cooled), and the number of weights 62 accommodated in the inner space S2 according to the weight of the charging cable 2 may be different.

If the charging cable 2 is of low weight, three weights 62 may be stacked in the inner space S2, if the charging cable 2 is of medium weight, six weights 62 may be stacked in the inner space S2, and if the charging cable 2 is heavy, nine weights 62 may be stacked in the inner space S2.

The weight assembly 6 may further comprise a roller 65 for movement control.

The roller 65 for movement control may be disposed on the tray 61 and may be in contact with the inner surface of the body 5.

The roller 65 for movement control may be configured to reduce frictional resistance between the tray 61 and the body 5.

The roller 65 for movement control may comprise a bracket mounted on the tray 61 and a roller disposed on the bracket to rotate around a horizontal axis and roll along the inner surface of the body 5.

The tray 61 may be smoothly lifted and lowered along the inner surface of the body 5 by the roller 65 for movement control.

The roller 65 for movement control may comprise an upper roller 66; and a lower roller 67.

The upper roller 66 may be rotatably disposed on the upper surface of the tray 61. The upper roller 66 may be disposed on the upper surface of the upper plate 61d of the tray 61.

The lower roller 67 may be rotatably disposed on the lower surface of the tray 61. The lower roller 67 may be disposed on the lower surface of the lower plate 61e of the tray 61.

The weight assembly 6 further comprises a front cover 68.

The front cover 68 is coupled to the tray 61 to prevent the weight 62 from leaving.

An upper fastening portion fastened to the upper plate 61d of the tray 61 may be formed at the upper end of the front cover 68, and a lower fastening portion fastened to the lower plate 61e of the tray 61 may be formed at the lower end of the front cover 68.

The horizontal width of the front cover 68 may be shorter than the horizontal width of the tray 61. The front cover 68 may be disposed to shield a portion of the front surface of the tray 61. The front cover 68 may be disposed to shield the front center of the tray 61.

The weight assembly 6 may further comprise a weight balancer 69.

The weight balancer 69 may be placed on the lower surface of the tray 61.

The weight balancer 69 may be placed on the lower plate 61e of the tray 61. Weight balancer 69 may be a bottom weight balancer. The weight balancer 69 may be an outer weight disposed outside the inner space S2.

The weight of the weight balancer 69 may be lighter than the weight of the weight 62.

For example, if the weight 62 is 3 kg, the weight balancer 69 may be 0.5 kg.

As many weights as possible may be disposed on the tray 61 by the weight balancer 69.

The weight 62 accommodated in the inner space S2 of the tray 61 may be a main weight balancer, and the weight balancer 69 disposed on the lower plate 61e of the tray 61 may be a bottom weight balancer.

The weight balancer 69 may be fixed to the lower surface of the lower plate 61e of the tray 61 with a fastening member such as a screw.

The wire device 3 may further comprise a left cover 9; and a right cover 10.

The left cover 9 and the right cover 10 may prevent the weight assembly 6 from arbitrarily leaving to the outside of the body 5.

The left cover 9 may be coupled to the front surface of the body 5.

The right cover 10 is coupled to the front surface of the body 5 and may be spaced apart from the left cover 9 in the left and right direction.

The wire device may further comprise a top stopper 11.

The top stopper 11 may be disposed on the upper portion of the body 5 to protrude into the space S1 of the body 5. The top stopper 11 may be disposed on at least one of the left plate 51 and the right plate 52 of the body 5 to protrude into the space S1.

The height of the top stopper 11 may be lower than the height of the first and second fixing pulleys 7 and 8.

The weight assembly 6 may be caught on the top stopper 11 in an upward direction. The top stopper 11 may determine the upper limit height of the weight assembly 6.

The weight assembly 6 may be caught in contact with the top spotter 11 before contacting the first and second fixing pulleys 7 and 8, and the top stopper 11 may prevent the first and second fixing pulleys 7 and 8 from being damaged by the weight assembly 6.

The wire device 3 may further comprise an outer pulley 12.

The outer pulley 12 may guide the inner wire 4A guided by the second fixing pulley 8 to the outside of the charger body 1 and may be exposed.

The outer pulley 12 may guide the outer wire 4B located outside the charger body 1 to the second fixing pulley 8.

The outer pulley 12 may be a third fixing pulley spaced apart from the second fixing pulley 8 in the horizontal direction.

The extension direction of the wire 4 may be changed to the downward direction by the outer pulley 12.

The charger body 1 may further comprise a deco body 13 on which an outer pulley 12 is disposed.

The outer pulley 12 may comprise a bracket fastened to the deco body 13 with a fastening member such as a screw, and a roller rotatably disposed on the bracket. The roller may be rotatably connected to the bracket about a horizontal axis.

The deco body 13 may be formed to protrude from the charger body 1, or may be manufactured separately from the outer body 1 and then fastened to the outer body 1.

The deco body 13 may be provided on the upper portion of the charger body 1. The deco body 13 may be disposed to protrude on the upper side of the charger body 1.

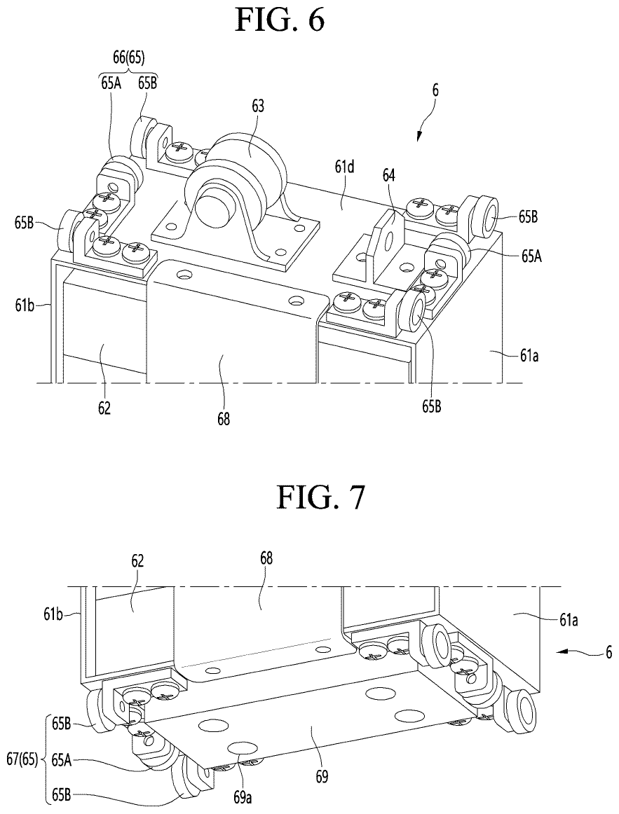

FIG. 6 is an enlarged perspective view illustrating the upper surface of the weight assembly according to this embodiment.

Among the rollers 65 for movement control, the upper roller 66 may further comprise a first roller 65A that rotates around a central axis in the front and rear direction; and a second roller 65B that rotates around the central axis in the left and right direction.

The first roller 65A and the second roller 65B constituting the upper roller 66 may be rotatably disposed on a bracket mounted on the upper surface of the upper plate 61d of the tray 61 with a fastening member such as a screw.

A pair of first rollers 65A may be provided. The pair of first rollers 65A may comprise a left first roller rolling along the left plate 51 of the body 5 and a right first roller rolling along the right plate 52 of the body 5.

Four second rollers 65B may be provided. The four second rollers 65B may comprise a pair of rear rollers that roll along the rear plate 53 of the body 5, a front left roller that rolls along the left cover 9, and a front right roller that rolls along the right cover 10.

FIG. 7 is an enlarged perspective view illustrating the lower surface of the weight assembly according to the present embodiment.

Among the rollers 65 for movement control, the lower roller 67 may be vertically symmetrical with the upper roller 66.

Among the rollers 65 for movement control, the lower roller 67 may further comprise a first roller 65A that rotates around a central axis in the front and rear direction; and a second roller 65B that rotates around the central axis in the left and right direction.

The first roller 65A and the second roller 65B constituting the lower roller 67 may be rotatably disposed on a bracket mounted on the lower surface of the lower plate 61e of the tray 61 with a fastening member such as a screw.

A pair of first rollers 65A may be provided. The pair of first rollers 65A may comprise a left first roller rolling along the left plate 51 of the body 5 and a right first roller rolling along the right plate 52 of the body 5.

Four second rollers 65B may be provided. The four second rollers 65B may comprise a pair of rear rollers that roll along the rear plate 53 of the body 5, a front left roller that rolls along the left cover 9, and a front right roller that rolls along the right cover 10.

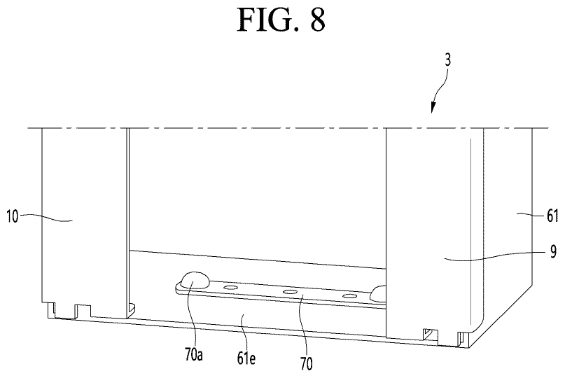

FIG. 8 is a perspective view illustrating the lower plate of the body when the weight assembly according to this embodiment is lifted.

The wire device 3 may further comprise a stopper 70 disposed on the upper surface of the lower plate 65 of the body 5.

When the external force is removed, the weight assembly 6 may fall to the lower plate 55 of the body 5 due to the own weight thereof, and the stopper 70 may minimize the shock generated when the weight assembly 6 falls.

The stopper 70 may be a bottom stopper made of an elastic material such as rubber.

A protrusion (70a or screw) may protrude from the stopper 70.

A groove 69a into which the protrusion 70a is inserted may be formed on the lower surface of the weight balancer 69.

When the weight assembly 6 falls, the protrusion 70a of the stopper 70 may be inserted into the groove 69a, and the weight assembly 6 may fall stably without distortion.

According to this embodiment, a wire is connected to a tray, and at least one weight is accommodated in the tray, so that the number of weights may be varied according to the weight of the charging cable.

In addition, the length of the wire accommodated inside the charger body may be maximized, and the movable length of the wire extending outside the charger body may be maximized.

Additionally, even if the size of the charger body is small, the wire may be accommodated inside the body as much as possible.

Additionally, the roller for movement control disposed on the tray is in contact with the inner surface of the tray, so that frictional resistance between the tray and the body may be minimized, and the tray may be lifted and lowered smoothly.

Additionally, the front cover installed on the tray may prevent the weight from randomly leaving.

Additionally, the left cover and the right cover placed on the body may prevent the weight assembly from randomly leaving and help the weight assembly lift and lower stably.

Additionally, the stopper may minimize the impact caused by the weight assembly falling.

Additionally, the upper limit height of the weight assembly may be determined by the top stopper, and damage to the first and second fixing pulleys by the weight assembly may be prevented.

The above description is merely an illustrative explanation of the technical idea of the present disclosure, and various modifications and variations will be possible to those skilled in the art without departing from the essential characteristics of the present disclosure.

Accordingly, the embodiments disclosed in the present disclosure are not intended to limit the technical idea of the present disclosure, but are for illustrative purposes, and the scope of the technical idea of the present disclosure is not limited by these embodiments.

The scope of protection of the present disclosure should be interpreted in accordance with the claims below, and all technical ideas within the equivalent scope should be interpreted as being comprised in the scope of rights of the present disclosure.

What is claimed is:

1. A charger configured to charge a battery of a vehicle, the charger comprising:
a charger body that includes a frame, the charger body configured to be mounted on the ground;
a body installed on the frame of the charger body and having a space therein;
a weight assembly accommodated in the space;
a charging cable that includes cable body and a connector, the connector being configured to be attached to a charging port of the vehicle; and
a wire connected to the charging cable and configured to raise and lower the weight assembly;
wherein the weight assembly comprises:
a tray with an inner space formed; and
at least one weight accommodated in the inner space.

2. The charger of claim 1, further comprising:
first and second fixing pulleys installed on the body,
wherein the weight assembly further comprises:
a lifting and lowering pulley disposed on the tray; and
a wire connector disposed on the tray and connected to the wire,
wherein the wire is sequentially wound around the first fixing pulley, the lifting and lowering pulley, and the second fixing pulley.

3. The charger of claim 1, wherein the weight assembly further comprises:
a roller configured to control movement, the roller being disposed on the tray and in contact with an inner surface of the body.

4. The charger of claim 3, wherein the roller comprises:
a first roller configured to rotate around a central axis in a front and rear direction; and
a second roller configured to rotate around a central axis in a left and right direction.

5. The charger of claim 3, wherein the roller for movement control comprises:
an upper roller rotatably disposed on an upper surface of the tray; and
a lower roller rotatably disposed on a lower surface of the tray.

6. The charger of claim 1, wherein the weight assembly further comprises:
a front cover coupled to the tray and configured to prevent the weight from leaving.

7. The charger of claim 1, further comprising:
a left cover coupled to a front surface of the body; and
a right cover coupled to the front surface of the body and spaced apart from the left cover in a horizontal direction.

8. The charger of claim 1,
wherein the body comprises a wire through-hole through which the wire passes, and
wherein the wire extends outside the body and is connected to the charging cable.

9. The charger of claim 8,
wherein the cable body extends outside of the charger body, and
wherein a first end of the wire is connected to the weight assembly, and a second end of the wire is connected to the cable body.

10. The charger of claim 1, further comprising:
a stopper disposed on an upper surface of a lower plate part of the body.

11. The charger of claim 10, wherein the weight assembly further comprises a weight balancer disposed on a lower surface of the tray.

12. The charger of claim 11,
wherein the stopper comprises a protrusion that protrudes from the stopper, and
wherein a groove into which the protrusion is inserted is formed on a lower surface of the weight balancer.

13. The charger of claim 1, further comprising:
a top stopper disposed on the tray, the top stopper configured to protrude toward the inner space.
